(19) United States
(12) Patent Application Publication
(10) Pub. No.: US 2015/0339451 A1
(43) Pub. Date: Nov. 26, 2015

(54) System and Method for Providing Mobile Electronic Assistance in Diagnostic and Therapeutic Medical Decisions and Documentation

(71) Applicant: Healthcare IT Solutions, LLC, Boonton, NJ (US)

(72) Inventors: Rolando Hector Rolandelli, Bedminster, NJ (US); Carlos Ignacio Rolandelli, Buenos Aires (AR); Carlos Alberto Rolandelli, Buenos Aires (AR)

(73) Assignee: Healthcare IT Solutions, LLC, Boonton, NJ (US)

(21) Appl. No.: 14/285,335

(22) Filed: May 22, 2014

(51) Int. Cl. G06F 19/00

(52) U.S. Cl. CPC G06F 19/3418; G06F 19/3431; G06F 19/345

(57) ABSTRACT

The present invention provides a system and method of providing automated diagnostic and treatment technology available to healthcare providers for rapid assistance with the formulation of diagnoses (including low-likelihood diagnoses, which, if missed, would result in high patient risk), through: (a) efficient and thorough gathering of patient-specific information and symptoms; (b) comparing same against local and national diagnosis and treatment databases; (c) rendering accurate and appropriate diagnosis possibilities; (d) rendering corresponding high likelihood of success and appropriate under the circumstances treatment modalities not only prescribed, but explained and demonstrated; and (e) the ability to dynamically reassess the foregoing based upon additional patient-specific information and symptoms. The system and method allows all levels of general healthcare practitioners to render a higher level of expertise and sophistication than would otherwise be possible from such less-experienced healthcare providers, including in those situations typically requiring a trained specialist.

### FIELD OF THE INVENTION

The present invention provides a system and method for healthcare providers to significantly improve the likelihood of a positive patient outcome by making automated diagnostic and treatment technology available for rapid assistance with the formulation of diagnoses (including low-likelihood diagnoses, which, if missed, would result in high patient risk), through: (a) efficient and thorough gathering of patient-specific information and symptoms; (b) comparing same against local and national diagnosis and treatment databases; (c) rendering accurate and appropriate diagnosis possibilities; (d) rendering corresponding high likelihood of success and appropriate under the circumstances treatment modalities not only prescribed, but explained and demonstrated; and (e) the ability to dynamically reassess the foregoing based upon additional patient-specific information and symptoms. The system and method allows: (a) rural; (b) non-specialist; (c) general practitioners; and (d) other medical and healthcare personnel such as nurses, midwives, and nurse practitioners; to render a higher level of expertise and sophistication than would otherwise be possible from such less-experienced healthcare providers, including in those situations typically requiring a trained specialist.

### BACKGROUND

The expansion and availability of computing power, particularly data transfer speeds, personal computing devices, handheld mobile platforms, the Internet, and user interfaces capable of communicating complex medical tasks have resulted in physicians having access to a myriad of tools that can assist with specific patient-oriented tasks including diagnosing conditions, generating patient file records and formulating effective treatment plans.

To date, however, there has been no one tool or combination of tools (other than having a live instructor or specialist present to oversee the use and interpretation of current diagnostic and treatment tools and procedures) capable of not only all of the foregoing, but also capable of effectively transforming a general physician or a less-experienced health care provider into a “virtual” specialist via access to a system and database capable of communicating understandable diagnostic and treatment techniques and procedures not otherwise available to the practitioner. The system and method of the instant invention provides otherwise handicapped, through lack of experience and expertise, medical practitioners and healthcare providers with fingertip access to the necessary information and instruction to essentially allow that general or less-experienced practitioner to perform as well, to the extent possible and appropriate under the circumstances, as the most seasoned and expert specialist in a given situation. The present invention helps to transform the general or less experienced practitioner, for example a rural emergency room physician, into a specialist on a wide range of medical conditions.

While advances in electronic healthcare records have brought marked improvements to the efficient transfer of medical information amongst multiple healthcare providers, and are creating a robust and valuable database of health records; to date, many of the tools necessary to utilize that database have not existed. For example, simply granting the patient and/or health care practitioner access to those records does not necessarily result in more efficient or better healthcare. In fact, what has been absent from the healthcare landscape is a tool and system capable of interpreting the relevant data in an efficient manner in order to be able to provide diagnostic and treatment guidance. Information is meaningless without proper interpretation and implementation. Caregivers and medical providers need to be able to understand the information regardless of its language or formatting or coding. The information needs to be easily transportable across geographic boundaries in an effort to clinically integrate different care providers while maintaining full regulatory compliance. Finally, it is important to provide the tools, pattern recognition, algorithms and probability analysis required to synthesize the information at hand and teach that information quickly to the degree necessary to provide the “assigned” physician with the requisite skill of a specially chosen physician if location, time and expense were not factors.

Surgery for emergency conditions carries the highest rates of morbidity and mortality. Decisions regarding surgical emergencies command immediacy because time is of the essence. Often a surgeon will opt out from doing emergency room surgery after s/he develops expertise and specialization. The remaining surgeons who are saddled with the tasks of making these immediate decisions and executing emergency surgery often lack necessary expertise and experience. In such a triage situation, a quick decision may save a life. However, a wrong decision or a slow decision may lose a life. In that context, a quick decision that saves a life albeit at the cost of a limb or a partial paralysis may still be better than a slow decision that loses a life although, had there been time, would have saved not only the life but the limb too. If that same decision could be the quick decision, such results are possible.

Changes in medical economics are resulting in a downsizing of small community hospitals. These hospitals may now only offer outpatient services and emergency services. Patients suspected of having a surgical emergency are often transported to large, tertiary hospitals. Personnel staffing emergency rooms, including physicians and their extenders, are entrusted with making the correct diagnosis to embark on costly transfers.

Decisions made in the management of trauma victims have been standardized to follow strict protocols where most victims are young and healthy with mechanisms of injury that allow predictable effects on the body. However, patients with acute surgical emergencies often exhibit a broad range of precipitating conditions with multiple associated conditions and a broad range of possible diagnostic and therapeutic plans. The number of variables involved in these types of decisions is vast and said variables include both quantitative and qualitative parameters.

Emergency surgery involves many crucial and time-sensitive decisions that are left to physicians and their extenders who often lack knowledge and experience. It is therefore vital to facilitate the processing of information and the decision-making to arrive expeditiously at the correct diagnosis and most appropriate therapeutic path, that sometimes are not the most obvious diagnoses or therapeutic paths. It is in these more specialized circumstances that the present invention is an indispensable and vital life and limb saving tool.

Recent technological advances including greater access to computing power, reliable information and knowledge (in part because of increasing use and availability of technology, social media and social changes), experience with self-management programs and new legal requirements for patient involvement have all contributed to creating a new dynamic through which patients and citizens are redefining their roles as informed consumers in relation to health and social care. For example, rendering the individual capable of determining the relative merit, advisability and implications of proposed tests and procedures has enabled said individual to become more informed in the field of health.

For example, U.S. Pat. No. 8,521,553 titled, IDENTIFICATION OF HEALTH RISKS AND SUGGESTED TREATMENT ACTIONS which issued Aug. 27, 2013 discloses “[u]sing a brokerage system, a consumer of services is matched with a service provider and a comprehensive health management plan is generated for the consumer during the consumer's interaction with the brokerage system. The brokerage system uses a rules engine to identify one or more conditions of the consumer's health and generate one or more conditions of the consumer's health and generate one or more follow-up actions based at least in part on the consumer's identified health condition. The consumer is notified of at least one of the identified conditions and the generated follow-up actions.”

In another example, U.S. Pat. No. 7,379,885 titled, SYSTEM AND METHOD FOR OBTAINING, PROCESSING AND EVALUATING PATIENT INFORMATION FOR DIAGNOSING DISEASE AND SELECTING TREATMENT which issued May 27, 2008 discloses, “[a] computer-based system and method which constructs medical histories by direct interactions between the patient and system that acquires pertinent and relevant medical information covering the complete life of a given patient. The system and method insure that a complete life long medical history is acquired from every patient interacting with the health care system. Once acquired, the facts of the patient's life long and family medical history are analyzed automatically by databases to generate a set of the most reasonable diagnostic possibilities (the differential diagnosis) for each medical problem identified and for each risk factor for disease that is uncovered in the historical database. Further, the automatically analyzed database of historical medical information is used as the search tool for bringing to bear, on the diagnosis and treatment of each medical problem identified in each patient, the entirety of medical knowledge that relates to and can be useful for the correct and efficient diagnosis and treatment of each of every patient's medical problems. This collection of information is analyzed to generate a final diagnosis and treatment regimen.”

In another example, U.S. Pat. No. 8,494,869 titled METHOD AND SYSTEM FOR PRESENTING TREATMENT OPTIONS, which issued Jul. 23, 2013 discloses, “a method for presenting a plurality of treatment options. The method includes obtaining medical information associated with an individual, wherein the medical information specifies an individual condition. The method further includes obtaining treatment information associated with the individual condition from a first plurality of benefit claims, generating the plurality of treatment options using the treatment information, and presenting the plurality of treatment options to a user.”

In another example, U.S. Pat. No. 8,548,827 titled COMPUTER IMPLEMENTED METHOD FOR MEDICAL DIAGNOSIS SUPPORT, which issued Oct. 1, 2013 discloses, “a computer-implemented method for medical diagnosis support for patient data of a patient through a data processing system, wherein the data processing system comprises a graphical user interface and a database containing rules for calculating diagnosis risks.”

In another example, a public disclosure available at www.isabelhealthcare.com discloses “a practical and dynamic diagnosis checklist within the normal workflow either as a standalone tool or fully integrated with the Electronic Medical Record (EMR). Isabel enhances the diagnostic determination process by complimenting the expertise of the clinician, minimizing risk at the most important decision point in the care process . . . . Accessed directly or fully integrated with an EMR system, the web-based Isabel tool uses the patient's demographics and clinical features to produce a list of possible diagnoses, including time-sensitive ‘Don't Miss Diagnoses.’ The tool integrates knowledge resources from leading publishers, together with local resources, to form a unique and practical knowledge organizer.”

There remains, therefore an unmet need for a device and system and method that enables a healthcare provider to gain rapid assistance with formulation of diagnoses (including low likelihood diagnoses, that if missed, would result in high patient risks) through: (a) efficient and thorough gathering patient-specific information and symptoms; (b) comparing same against local and national diagnosis and treatment databases; (c) rendering accurate and appropriate diagnosis possibilities; (d) rendering corresponding high likelihood of success and appropriate under the circumstances treatment modalities not only prescribed, but explained and demonstrated; and (e) the ability to dynamically reassess the foregoing based upon additional patient-specific information and symptoms. The present invention allows: (a) rural; (b) non-specialist; (c) general practitioners; and (d) other medical and healthcare personnel such as nurses, midwives, and nurse practitioners; to render a higher level of expertise and sophistication than would otherwise be possible from such less-experienced healthcare providers, including those situations typically requiring a trained specialist. It essentially transforms an emergency room attendant into any number of trained specialists with the power to make correct quick decisions and carry out the procedures in an as close to expert manner as possible.

### SUMMARY

The present invention provides a solution to the unmet need, by providing a system that enables a user to access and utilize a computer application loaded onto a computing device to provide assistance with diagnosis and treatment, the system comprising:
a) a computing device application;
b) a computing device;
c) a user interface;
d) wherein said interface grants said user access to said application loaded onto said computing device configured to:
   (i) gather patient specific data;
   (ii) interface with established databases of healthcare information;
   (iii) compare said patient specific data with said established databases of healthcare information;
   (iv) generate and display possible diagnoses in order of likelihood;
   (v) generate and display at least one treatment option for any given and non-excluded diagnosis;
   (vi) generate a therapeutic plan;
   (vii) generate at least one electronic health record relating to said patient.

In one embodiment, the system of the present invention also prompts said user to consider lower likelihood diagnoses that if true and dismissed pose a high risk to said patient.

In one embodiment, the system of the present invention is implemented in a handheld mobile computing device.

In one embodiment, the system of the present invention is configured to guide said user to implement diagnostic modalities of proven efficacy for any given and non-excluded diagnosis.

In one embodiment, the system of the present invention is configured to guide said user to implement therapeutic modalities of proven efficacy for any given and non-excluded diagnosis.

In one embodiment, the system of the present invention is configured to demonstrate, guide, instruct and complement a user to provide a level of treatment said user would not otherwise be capable of providing.

In one embodiment, the system of the present invention is configured to correct and re-diagnose based upon input resulting from treatment or other changes.

In one embodiment, the system of the present invention is configured to receive manually inputted patient specific information.

In one embodiment, the system of the present invention is configured to interface with medical diagnostic tools to receive patient-specific information.

In one embodiment, the system of the present invention is configured to interface with medical treatment tools to receive patient-specific information.

In one embodiment, the system of the present invention is configured to enable a healthcare provider to perform a real-time examination and input corresponding patient-specific data.

In one embodiment, the system of the present invention is configured to create a patient data file containing at least one category of information pertinent to said patient.

Each of the elements of the system and method contribute to enable a healthcare provider to achieve the goal of accessing and utilizing a mobile computer application in order to receive assistance with medical decisions, documentation, and procedure implementation with the goal of rendering consistent potential treatment options with therapeutic modalities of proven efficacy with added functionality of generating documentation for an electronic health record and providing expert guidance to a less-experienced healthcare provider for any provided treatment option including those typically requiring a trained specialist.

In one embodiment, the present invention is capable of gathering patient specific information from other patient data repositories, such as Electronic Health Records databases, hospital records databases, other patient file databases, Internet databases coded to correlate specifically with the specific patient at issue, and the like. One of skill in the art will appreciate the many repositories of patient data from which the system of the present invention should be able to glean data.

In one embodiment, the present invention will create a patient data file containing all gleaned information organized in several manners, including but not limited to, chronologically, symptom parameter, deviation from normal range, deviation from prior reading, severity of symptom data, and the like.

For example, it may be relevant that, with respect to a specific patient's blood pressure, although all readings over several years are within acceptable normal limits, the readings have progressively changed indicating some manifestation of illness. In other cases, it may be more relevant that a specific reading is extremely above or below acceptable normal limits. By organizing data in different manners, these different relevant comparisons will become apparent.

In one embodiment, the present invention will compare all patient data with data of local and national databases and all different manner of organization of same with the goal of identifying all possible diagnoses for a given set of symptoms, including low likelihood conditions with high patient risk.

For example, appendicitis is generally thought of as low incidence in children under age 10. Additionally, children under 10 often have difficulty describing their symptoms with specificity. Typical symptoms of appendicitis, abdominal pain, loss of appetite, nausea, vomiting, diarrhea, and fever are common to many maladies, including common and non-serious conditions. Thus, more than 80% of children younger than 3 who have appendicitis already have a rupture by the time they reach the operating room and most have already been seen by a health professional. The present invention will force a physician to exclude the condition of appendicitis in a three year old presenting with the listed symptoms. Although many times the actual condition may be something as common as a stomach virus, the possibility of missing the serious when left untreated condition of appendicitis will be reduced.

The present invention aims to ease the input of data and process said data efficiently. The present invention formulates a plan with scientific logic and models outcome probabilities. The present invention provides assistance in the selection of technique and planning of surgery. The present invention produces documentation for preparation, execution, and recuperation from surgery.

### BRIEF DESCRIPTION OF THE DRAWINGS

FIG. 1 depicts an organizational representation of one embodiment of the system and method of the present invention as a whole, demonstrating global inputs, outputs, and other operations.

FIG. 2 depicts a flowchart representation of one embodiment of the system and method of the present invention as operations and functions flowing on an application loaded onto a mobile device.

FIG. 3 depicts an organizational representation of one embodiment of types of inputs available to the Core Module of the system and method of the present invention, including patient history through interview, examination, and studies from labs and imaging.

FIG. 4 depicts an organizational representation of one embodiment of the system and method of the present invention illustrating communication flow with databases and documents, retrieving input from the databases and documents and sending output diagnosis, treatment, prognosis and surgical option.

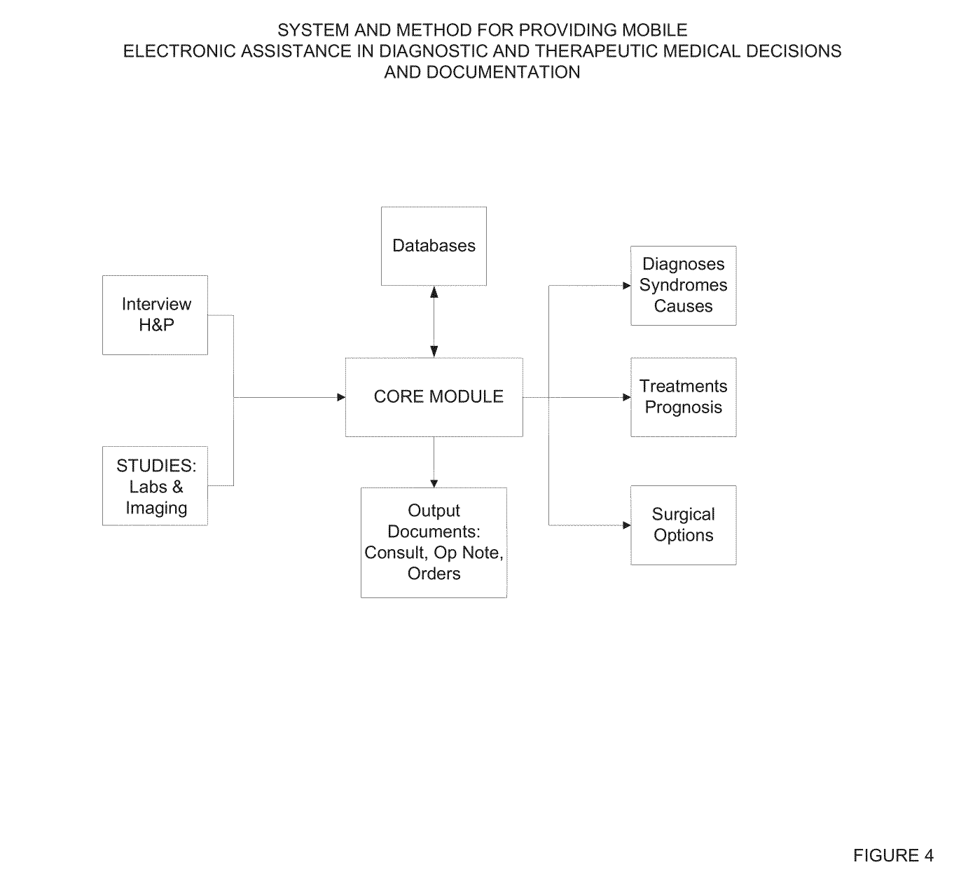

FIG. 5 depicts an organizational representation of one embodiment of the system and method of the present invention of the interplay between an additional billing module and the documents pertinent to the application.

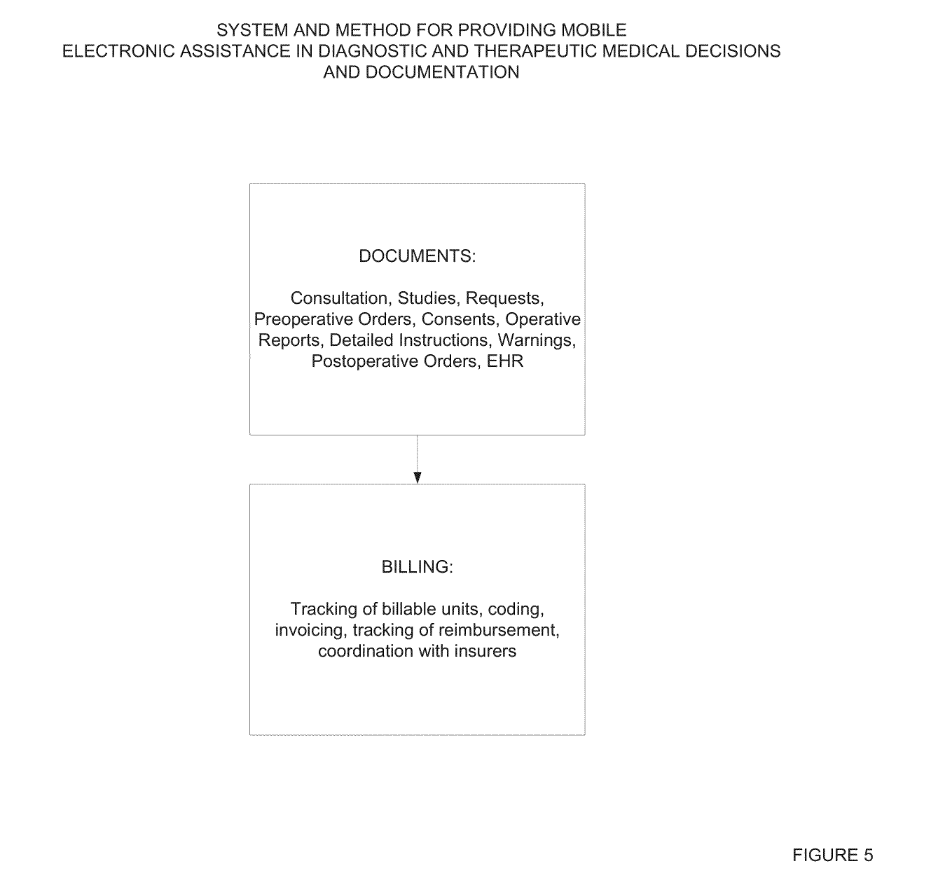

FIG. 6 depicts an organizational representation of one embodiment of the system and method of the present invention of typical outputs, including diagnoses, treatments, prognosis, and surgical options.

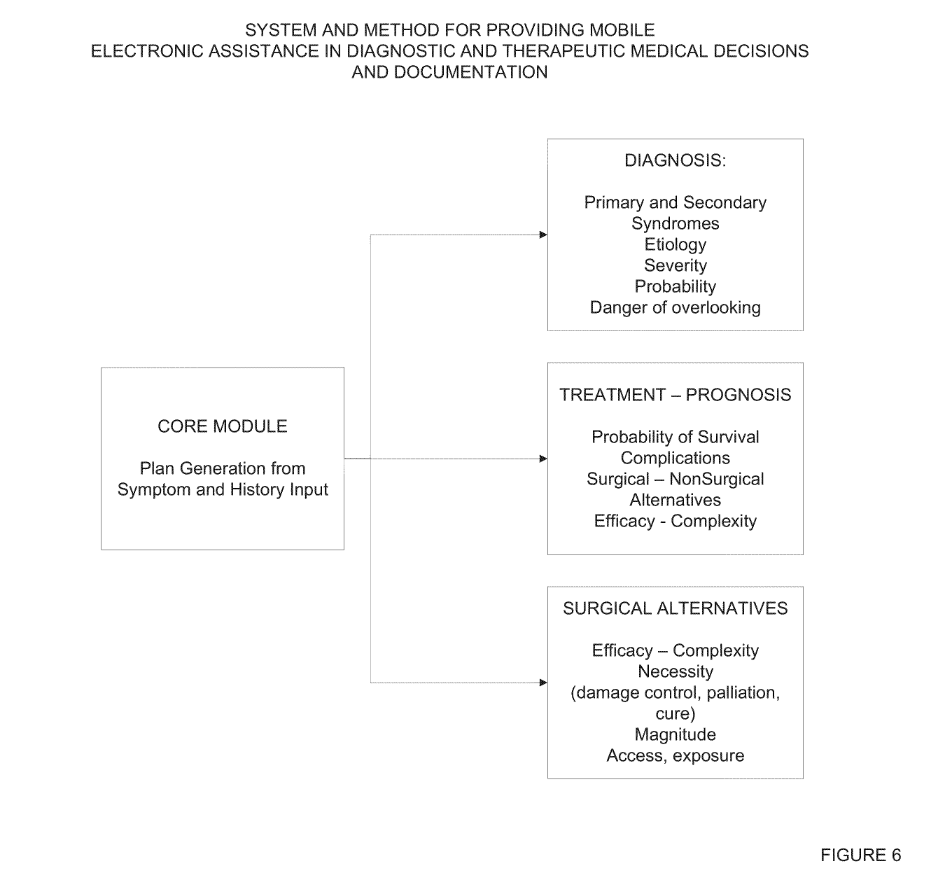

FIG. 7 depicts an organizational representation of one embodiment of the system and method of the present invention illustrating possible additional modules to further facilitate the diagnoses, treatments and prognosis, and surgical options to provide solutions for patients.

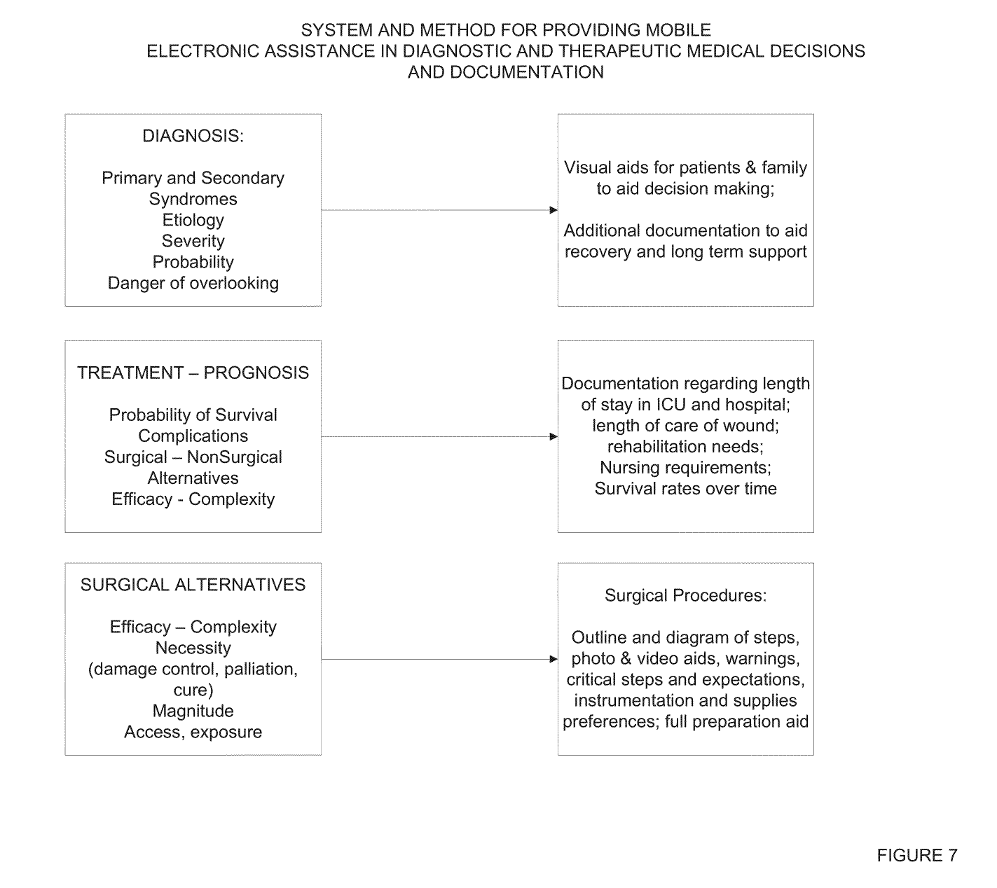

FIG. 8 depicts a graphical representation of one embodiment of the system and method of the present invention of a login procedure on a handheld mobile platform and an initial menu procedure.

FIG. 9 depicts a graphical representation of one embodiment of the system and method of the present invention of an example procedure on a handheld mobile platform which enables a user to enter biological information and complaint and further depicts a representation of another step which enables a user to enter more details about said complaint.

FIG. 10 depicts a graphical representation of one embodiment of the system and method of the present invention of a procedure on a handheld mobile platform which enables a user to enter information pertinent to medication and allergies and further depicts a representation of another step which enables a user to enter details about past medical history and past surgical history.

FIG. 11 depicts a graphical representation of one embodiment of the system and method of the present invention of a procedure on a handheld mobile platform which enables a user to enter information pertinent to social history and occupation and further depicts a representation of another step which enables a user to enter details about organ systems.

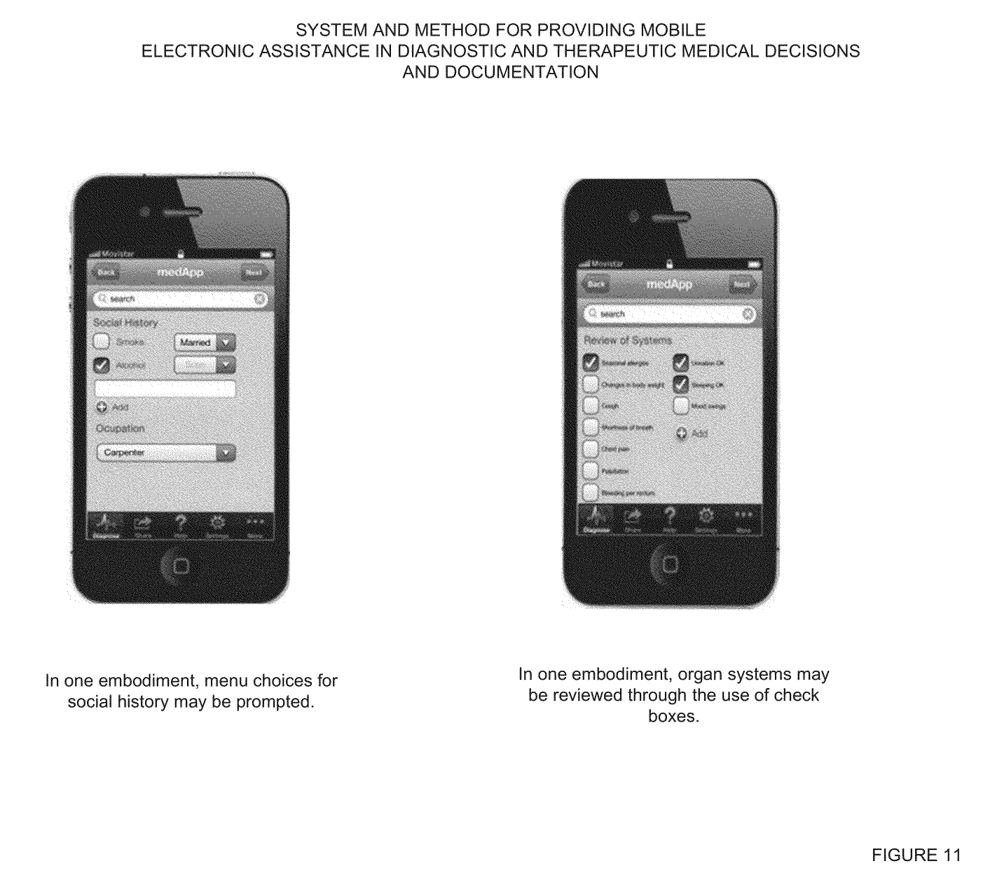

FIG. 12 depicts a graphical representation of one embodiment of the system and method of the present invention of a procedure on a handheld mobile platform which enables a user to enter information pertinent to vital signs and further depicts a representation of another step which enables a user to enter, in real time, details about a physical exam of said user.

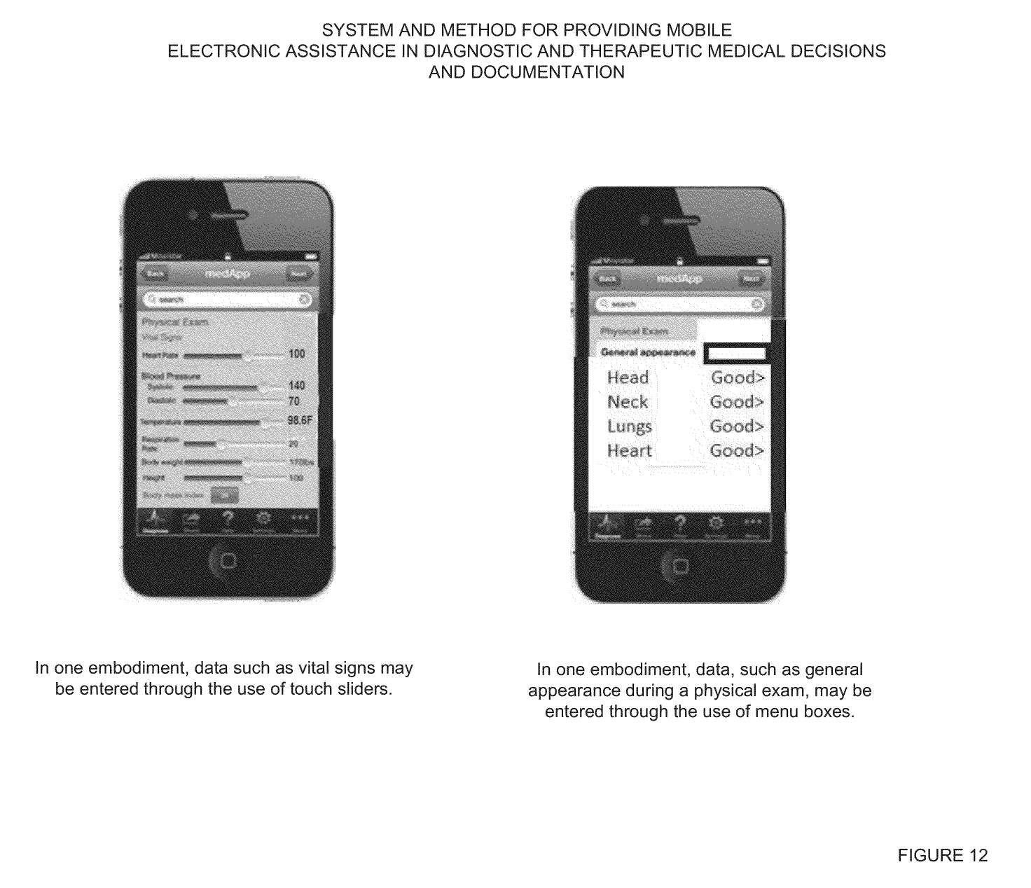

FIG. 13 depicts a graphical representation of one embodiment of the system and method of the present invention of a procedure on a handheld mobile platform which enables a user to enter information pertinent to a physical exam and further depicts a representation of another step which enables a user to enter details about a specific anatomic area.

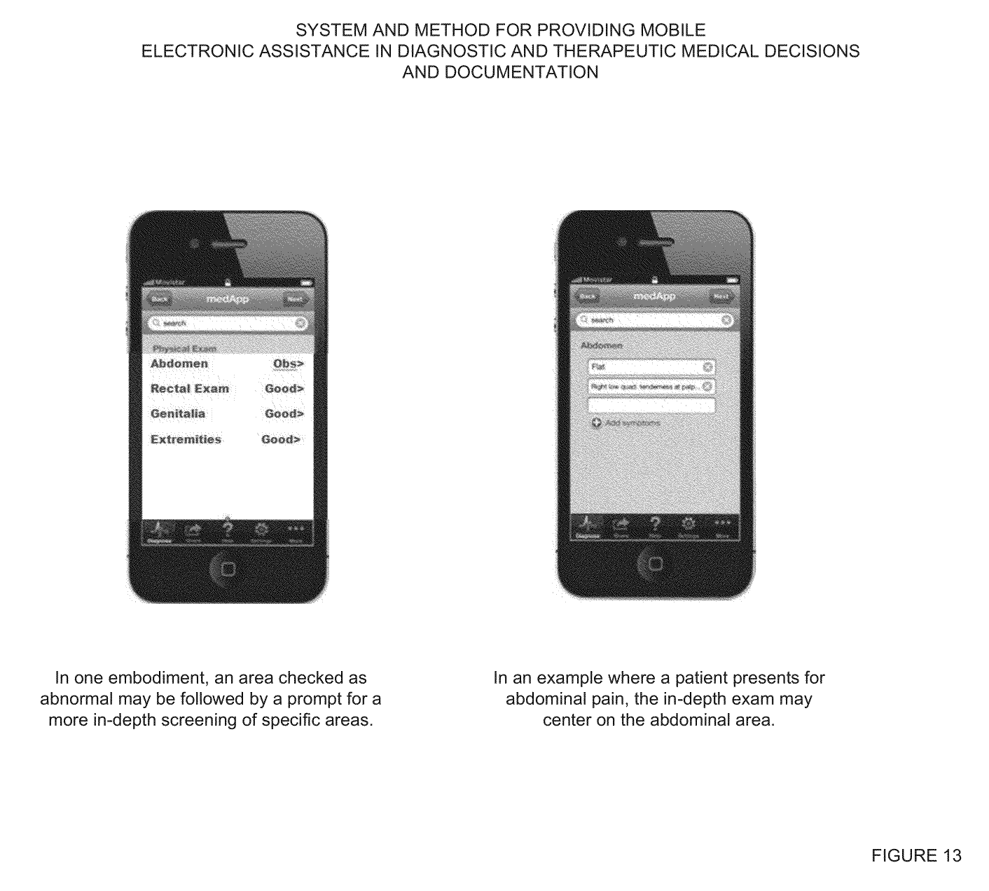

FIG. 14 depicts a graphical representation of one embodiment of the system and method of the present invention of a procedure on a handheld mobile platform which enables a user to receive potential diagnoses and further depicts a representation of another step which provides a user with options to order tests to validate the diagnosis.

FIG. 15 depicts a graphical representation of one embodiment of the system and method of the present invention of a procedure which enables a user to order at least one test and further depicts a representation of another step which provides a user with a list of risks, at least one diagnosis, and at least one proposed surgical option accompanied by risks associated with the patient's clinical condition and the complexity of the treatment.

FIG. 16 depicts an organizational representation of one embodiment of the system and method of the present invention illustrating the use of database input to calculate probabilities using known statistical analyses paradigms (such as, POSSUM (Physiological Operative Severity Score for the enumeration of Mortality and morbidity); p-POSSUM (Portsmouth modification of POSSUM); SRS (Surgical Risk Score); BHOM (Biochemistry and Haematology Outcome Models); RGCRI (Revised Goldman Cardiac Risk Index); and/or other known statistical health analyses factors) and generate document output related to said analyses and illustrating potential uses and handling of said document output.

FIG. 17 a flowchart representation of one embodiment of the system and method of the present invention as menu driven queries to generate associated diagnosis and illness values to provide the user with risk assessment and surgical options.

### DETAILED DESCRIPTION

For clarity of disclosure, and not by way of limitation, the detailed description of the invention is divided into the following subsections that describe or illustrate certain features, embodiments or applications of the present invention.

### DEFINITIONS

“Healthcare provider” or “healthcare facility” as used herein means an organization, entity, or individual, such as, for example, a hospital, clinical laboratory, physician, physical therapist, outpatient service provider, home health care provider, insurance company, and the like, that provides any treatment or services related to the treatment of the health and/or well being of an individual.

The term “healthcare record” or “medical record” as used herein refers to the documentation of the body of information, or any portion thereof, that comprises a patient's individual medical history and care, including, but not limited to information sufficient to identify the patient, information on medical encounters, orders and prescriptions, history of the present illness/complaint, previous illnesses, diagnoses, prognoses, physical examinations, x-rays, lab test results, digital images of the patient, informed consent forms, insurance information, billing records, patient tendencies and the like.

“Electronic health record” or “EHR” as used herein refers to a computerized record, or any portion thereof, of the documentation of a patient's medical record.

### The System and Method of the Present Invention

One embodiment of the system and method of the present invention comprises:
a) a mobile electronic device application;
b) a mobile electronic device;
c) a graphical user interface;
d) wherein said graphical user interface grants a healthcare provider access to said application loaded onto said mobile electronic device configured to:
   (i) gather patient specific data;
   (ii) interface with established databases of medical information;
   (iii) compare said patient specific data with said established databases of medical information;
   (iv) generate and display possible diagnoses in order of likelihood;
   (v) prompt said healthcare provider to consider and exclude low-likelihood diagnoses that if true and dismissed would pose a high risk to said patient;
   (vi) generate and display at least one treatment option for any given and non-excluded diagnosis;
   (vii) guide said healthcare provider to use diagnostic and therapeutic modalities of proven efficacy for any given and non-excluded diagnosis;
   (viii) demonstrate, guide, instruct and complement a qualified but otherwise less-experienced healthcare provider through any provided treatment option;
   (ix) correct and re-diagnose based upon follow on input resulting from treatment or other changes;
   (x) generate a therapeutic plan; and
   (xi) generate at least one electronic health record relating to said patient.

In one embodiment, a mobile electronic device application loads a graphical user interface. The graphical user interface grants a healthcare provider access to said application.

In one embodiment, the application is configured to gather patient specific data and interface with established databases of medical or other healthcare information.

In one embodiment, the application then compares the patient specific data with the established databases of medical or other healthcare information.

In one embodiment, the application generates and displays possible diagnoses in order of likelihood based on the correlation of patient specific data to the established databases of medical information and further prompts the healthcare provider to consider and exclude low-likelihood diagnoses that if true and dismissed, would pose a high risk to the patient.

In one embodiment, the application generates and displays at least one treatment option for any given and non-excluded diagnosis. The application further guides the healthcare provider to use diagnostic and therapeutic modalities of proven efficacy for any given and non-excluded diagnosis. The application may demonstrate regarding, guide, and otherwise instruct and/or complement a qualified but otherwise less-experienced health care provider through any provided treatment option.

In one embodiment, the application corrects and re-diagnoses based upon further input resulting from treatment or other changes.

In one embodiment, the application generates a therapeutic plan, which can be short term or long term, and generates all applicable electronic health records relating to a patient.

In one embodiment, the mobile electronic device application of the present system and method is a hand-held, menu-driven, touch-screen pocket-size device.

In one embodiment, the device is not pocket size.

In one embodiment, the mobile electronic device application of the present system and method includes a processing program.

In one embodiment, the processing program is configured to assess all inputted patient information where such patient is presenting with acute surgical emergencies and displaying a broad range of precipitating conditions with multiple associated conditions and a broad range of possible diagnostic and therapeutic paths to assist the attending health care provider in correctly identifying where and when strict standard protocols require deviation in order to obtain the best possible outcome. The number of variables involved in such decisions is vast and include both quantitative and qualitative parameters that in an emergency setting are typically made by service providers lacking in the requisite experience and under extreme time constraints who would be most helped by any time saving and unbiased symptom assessment tool.

In one embodiment, the mobile electronic device application of the present system and method can be used by a healthcare provider conducting various forms of surgery, including vascular, thoracic, urological, orthopedic, gynecological, neurological, cardiac, plastic, and trauma surgery. The mobile electronic device application of the present system and method can be used by healthcare providers in various fields, including emergency, gastroenterology, pulmonary and cardiology medicine. The examples herein should not be read to be limiting as the device and system of the present invention may be used in any surgery and in any field of endeavor of healthcare services.

In one embodiment, the mobile electronic device application of the present system and method is capable of handling different languages as well as understanding communication protocols within the healthcare industry, including but not limited to nursing decision making, anesthesiologist decision making and physical therapy decision making.

In one embodiment, the mobile electronic device application of the present system and method is designed to manage multiple patients simultaneously.

In one embodiment, the mobile electronic device application of the present system and method is capable of aiding decision making for doctors and staff in a doctor's office and the decision making of consumers of health care services.

In one embodiment, a user can download the application under a hospital's license.

In one embodiment, a user can download the application under a healthcare provider's license.

In one embodiment, the mobile electronic device application of the present system and method is configured to enable a healthcare provider to conduct medical decision-making, documentation and procedure implementation for a new patient or for a previous patient.

In one embodiment, the present invention is capable of receiving manually inputted patient specific information.

In one embodiment, the mobile electronic device application of the present system and method is configured to enable the user to conduct an interview of a patient, ascertaining medical history in the form of present illness, past illnesses and surgeries, social history, and allergy history.

In one embodiment, the present invention is capable of interfacing with medical diagnostic tools to receive patient specific information directly.

In one embodiment, the healthcare provider performs a real-time examination and enters patient data either manually or through interfacing with other tools.

In one embodiment, the mobile electronic device application of the present system and method is configured to interface with hospital computer systems, including laboratories and radiology systems and the databases thereof.

In one embodiment, templates used to input data of a patient may include at least one of electronic medical record history, a physical examination, and diagnostic studies.

In one embodiment, the mobile electronic device application of the present system and method is configured to enable the uploading of demographics through a combination of manual entry and direct transfer from hospital systems.

In one embodiment, the mobile electronic device application of the present system and method interfaces with a hospital's portal system of medical information and with various databanks coded by medical disciplines.

In one embodiment, the present invention is capable of gathering patient specific information from other patient data repositories, such as electronic health records databases, hospital records databases, other patient file databases, Internet databases coded to correlate specifically with the specific patient at issue, or otherwise password protected, and the like.

In one embodiment, the mobile electronic device application of the present system and method processes data gathered through pattern recognition, algorithms and probability analyses.

In one embodiment, the mobile electronic device application of the present system and method gathers data pertaining to a systems physical examination, including physiological parameters and a head-to-toes examination.

In one embodiment, the mobile electronic device application of the present system and method gathers data pertaining to studies from laboratories, including Complete Blood Count, chemistries, Liver Function Test, coagulation test, and lactic acid studies, and from imaging studies, including x-ray, Computed Tomography, and Ultrasound imaging and any known diagnostic testing pertinent to a specific patient status.

In one embodiment, the present invention will create a patient data file containing all gleaned information organized in several manners, including but not limited to, chronologically, symptom parameter, deviation from normal range, deviation from prior reading, severity of symptom data, and the like.

In one embodiment, the present invention will compare all patient data with data of local and national databases and other organizations with the goal of identifying all possible diagnoses for a given set of symptoms, including low-likelihood conditions with high patient risk.

In one embodiment, the mobile electronic device application of the present system and method processes data according to predefined formulas and algorithms based on statistical probability analyses weighting certain criteria according to past statistical observations based on a patient's given known criteria.

In one embodiment, the established databases include outcome data registries, sources of medical information and illustrations.

In one embodiment, at least one of said databases contains scientific information pertinent to diagnoses, severity scores, treatment options, and survival and complication probabilities.

In one embodiment, the mobile electronic device application of the present system and method prepares documents suitable for electronic download into hospital Electronic Medical Record and ordering systems.

In one embodiment, the mobile electronic device application of the present system and method is configured to enable a healthcare provider to complete billing tasks including tracking of billable units, coding, invoicing, and tracking of reimbursement.

In one embodiment, the mobile electronic device application of the present system and method computes probabilities and generates documents based on information from the established databases according to known statistical analyses.

In one embodiment, the mobile electronic device application of the present system and method is configured to generate and display a menu of medications in response to a given set of patient data.

In one embodiment, the mobile electronic device application of the present system and method is configured to enable a user to enter information pertinent to allergy history, medical history, surgical history, social history, and vital signs.

In one embodiment, the mobile electronic device application of the present system and method is configured to enable a user to receive information pertinent to body mass index.

In one embodiment, the mobile electronic device application of the present system and method is configured to generate and display questions about an anatomic area checked as abnormal by a user.

In one embodiment, the mobile electronic device application of the present system and method generates a preliminary list of diagnoses based on calculated probability of accuracy and suggested corroboratory evidence.

In one embodiment, the mobile electronic device application of the present system and method uses demographics, history, and physical examination results of the patient to propose a potential diagnosis with a percentage of likelihood of accuracy and also proposing alternative diagnoses with lower percentage likelihood of accuracy but with substantial to severe risks for discounting.

In one embodiment, the mobile electronic device application of the present system and method generates and displays potential laboratory work or imaging work that could corroborate or exclude a diagnosis.

In one embodiment, the mobile electronic device application of the present system and method renders a final list of diagnoses based on corroboratory and/or exclusionary evidence. The healthcare provider can acknowledge said final list and proceed with generating vital documentation, including consultation documents, consent documents, orders, or a letter to a primary healthcare provider.

In one embodiment, the mobile electronic device application of the present system and method is configured to generate and display a menu of choices for corroboratory and/or exclusionary examinations and routine preoperative testing.

In one embodiment, the mobile electronic device application of the present system and method generates plans for diagnoses based on syndromes, etiology and severity, generates plans for treatment and prognosis based on probability of survival and complications and non-surgical and surgical alternatives, and generates plans for surgical options based on effectiveness, with due regard for damage control, palliation, and cure, and based on magnitude, with due regard for minimal access and open exposure.

In one embodiment, the mobile electronic device application of the present system and method is configured to provide an estimate of an overall risk based on a patient's clinical condition, an estimate on complexity of a treatment, and an assessment of an ability of a patient to heal.

In one embodiment, the mobile electronic device application of the present system and method generates a prognosis which includes a length of stay in an Intensive Care Unit and hospital, a length of care for a wound, a need for rehabilitation or nursing, and a rate of survival in five years' time.

In one embodiment, the mobile electronic device application of the present system and method implements a therapeutic plan offering aids in text, photos or videos, any of which could communicate a step for an invasive procedure.

In one embodiment, the mobile electronic device application of the present system and method generates visual aids for proper decision-making regarding immediate recovery and long-term support.

In one embodiment, templates to produce outputs include templates and documents designed for consultation, preoperative orders, postoperative orders, and consents, which may include consent for surgery and blood products.

In one embodiment, the mobile electronic device application of the present system and method generates surgical procedures including an outline and diagram of steps, photo and video aids, instrumentation and supplies preferences.

In one embodiment, the mobile electronic device application of the present system and method is configured to generate, after confirmation of a diagnosis and surgery decision, a booking in an operating room along with surgeon preferences, consent, history, and physical information.

In one embodiment, the mobile electronic device application of the present system and method is configured to generate and display a step-by-step review of an operation about to be performed.

In one embodiment, the mobile electronic device application of the present system and method is configured to generate and display bibliographic references for recommended decisions.

In one embodiment, a patient database may contain information regarding that patient's attending physician. Such information may include, for example, articles or other reference material that the user may wish to review, past discharge instructions, test results, biometric data, prescriptions, information on the patient's prior complaints, support groups, common side effects, and the like.

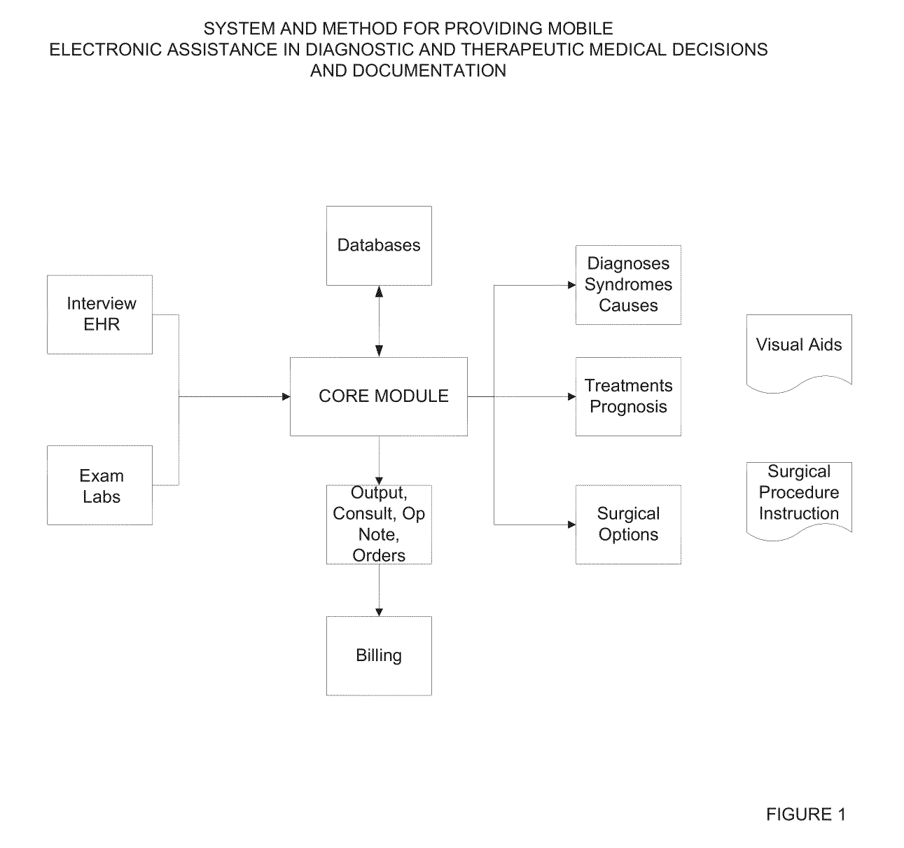

Referring to FIG. 1, in one embodiment, the Core Module of the system and method of the present invention may receive input from an interview with a patient, from prior EHR of the patient, from an examination of the patient and/or from tests performed on the patient and may also exchange information with other database repositories in order to generate output including but not limited to diagnoses, potential treatments, surgical options and other documentation.

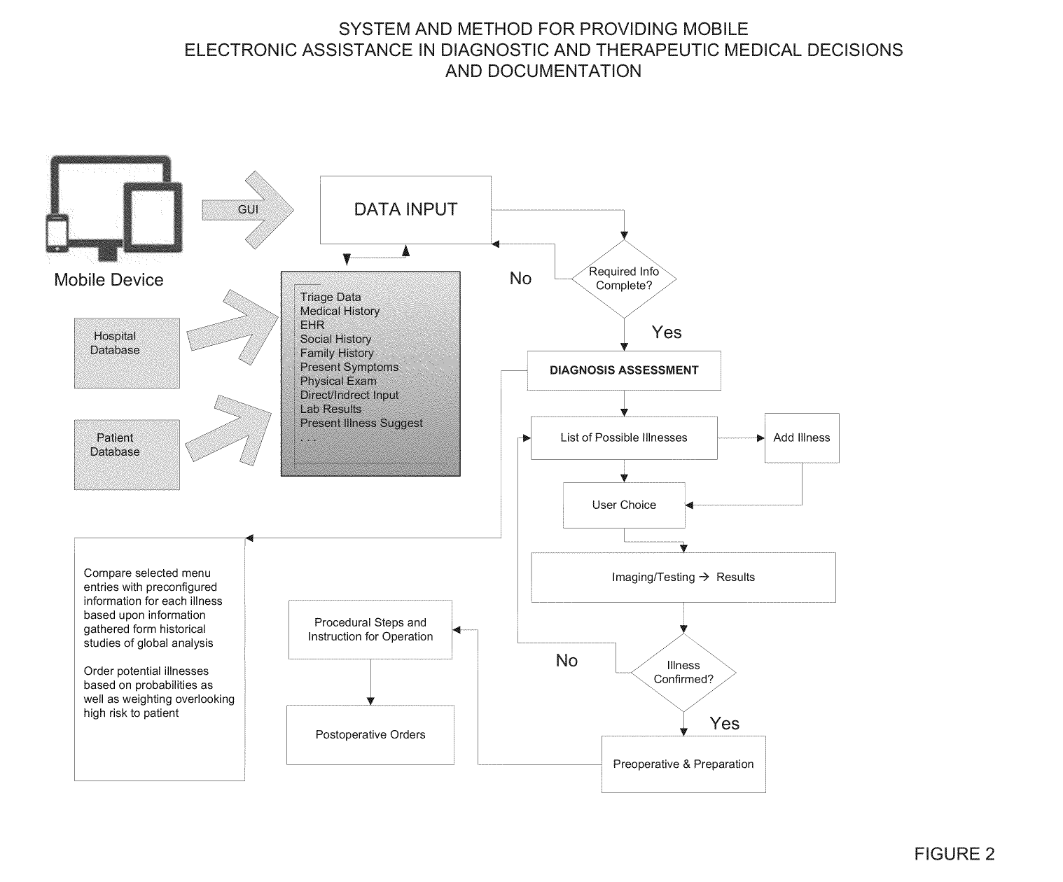

Referring to FIG. 2, in one embodiment, data input may be partially completed and a preliminary diagnosis assessment rendered and upon confirming a misdiagnosis, return to gather more data input, which may be accomplished by a variety of means and from a variety of sources.

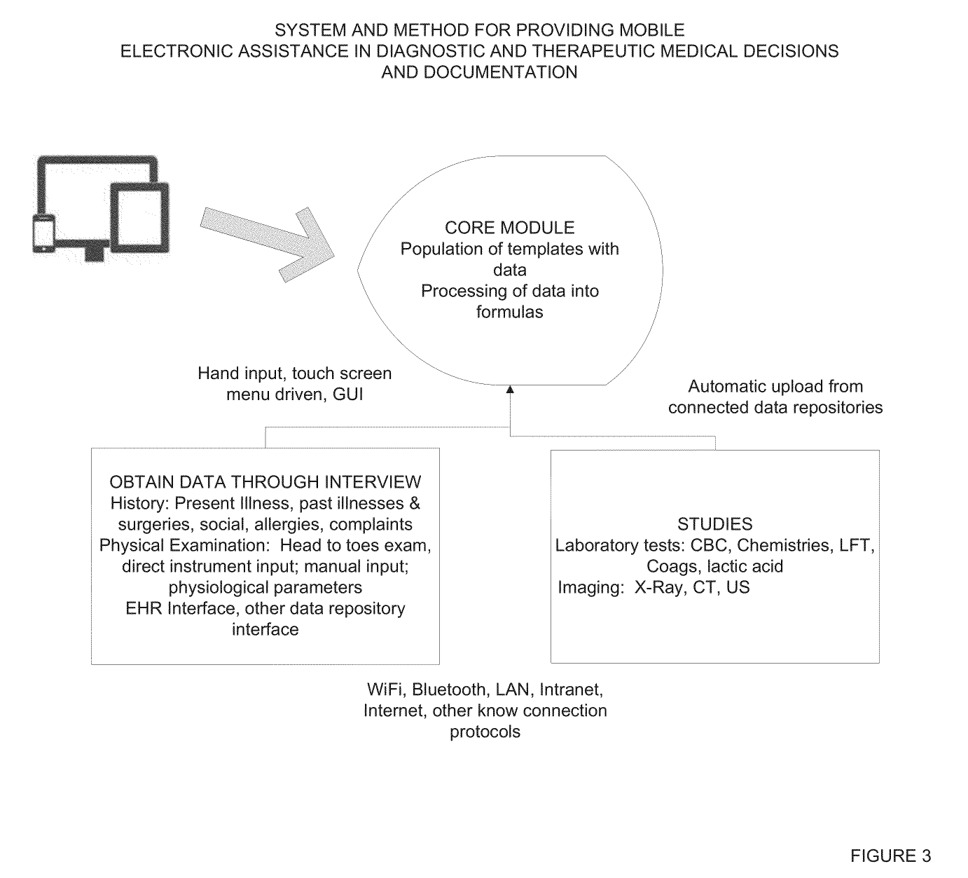

Referring to FIG. 3, in one embodiment, data input may be hand inputted, automatically uploaded through a variety of known connection protocols and through a series of menu driven, touch screen, GUI interfaced application prompts.

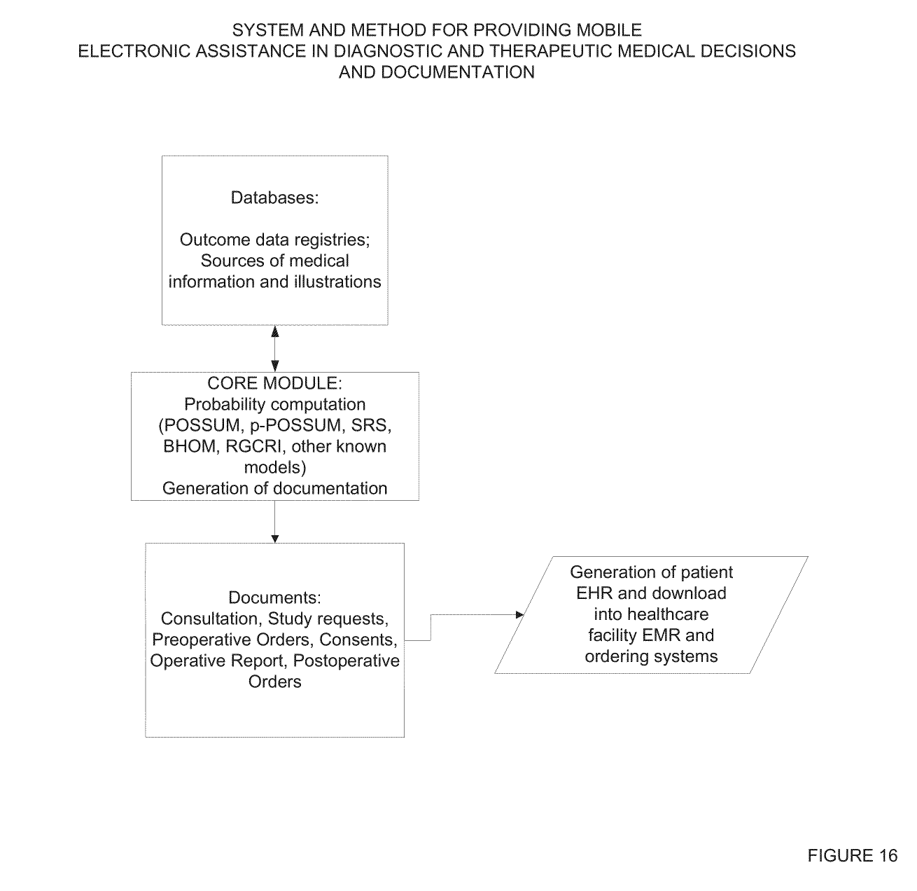

Referring to FIG. 16, in one embodiment, data inputted into the Core Module is processed according to known models of healthcare assessment statistical paradigms (such as, POSSUM (Physiological Operative Severity Score for the enumeration of Mortality and morbidity); p-POSSUM (Portsmouth modification of POSSUM); SRS (Surgical Risk Score); BHOM (Biochemistry and Haematology Outcome Models); RGCRI (Revised Goldman Cardiac Risk Index); and/or other known statistical health analyses factors) in order to generate a desired output of likelihood of illnesses and treatment options.

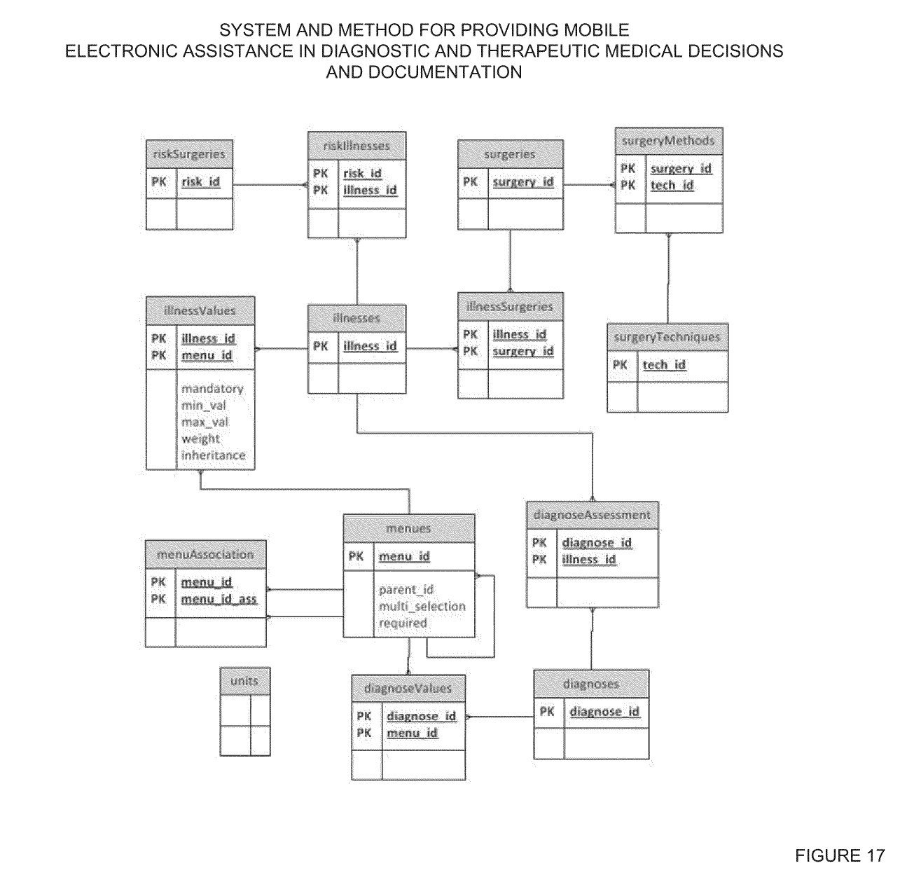

Referring to FIG. 17, in one embodiment, menus of certain input prompts may generate input that in turn generate various additional menu prompts.

The present invention is further illustrated, but not limited by, the following examples.

### EXAMPLES

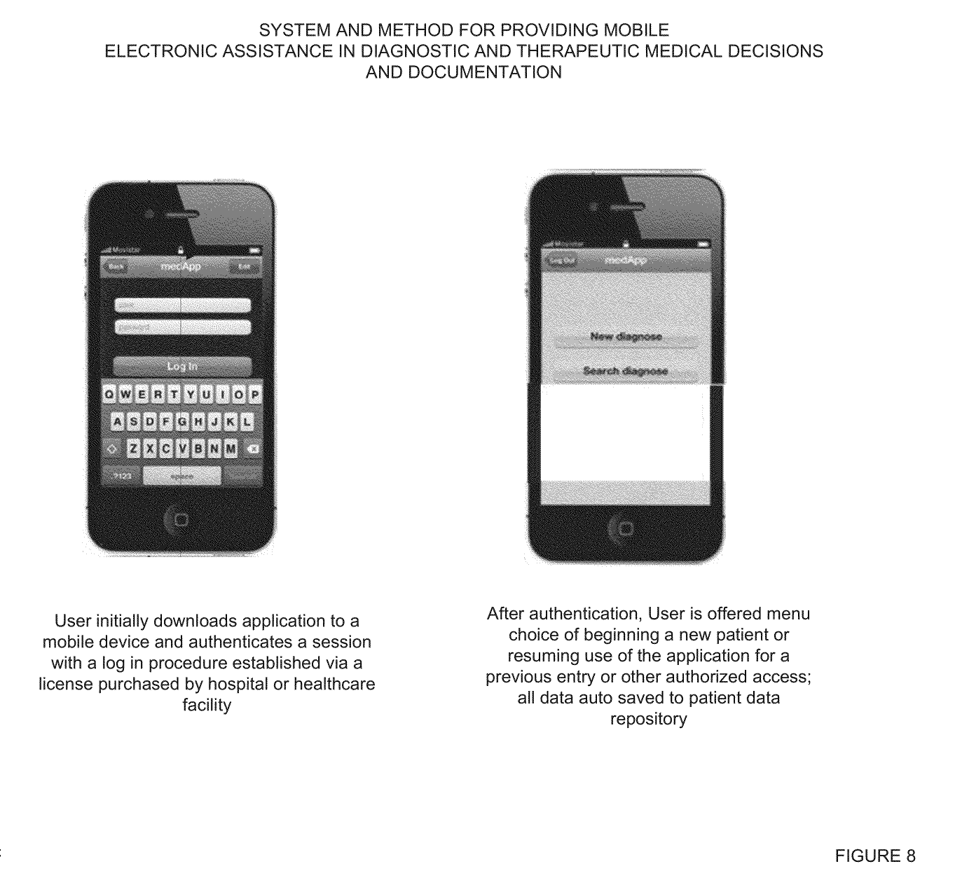

In one embodiment, referring to FIG. 8, the present invention provides a graphical user interface (“GUI”) suitable for first authenticating a user as a credentialed healthcare service provider.

In one embodiment, continuing with FIG. 8, upon launch of the GUI, the user is presented with a log-in screen and upon authentication, is presented with a menu choice to begin a “new” diagnosis or search for past patients.

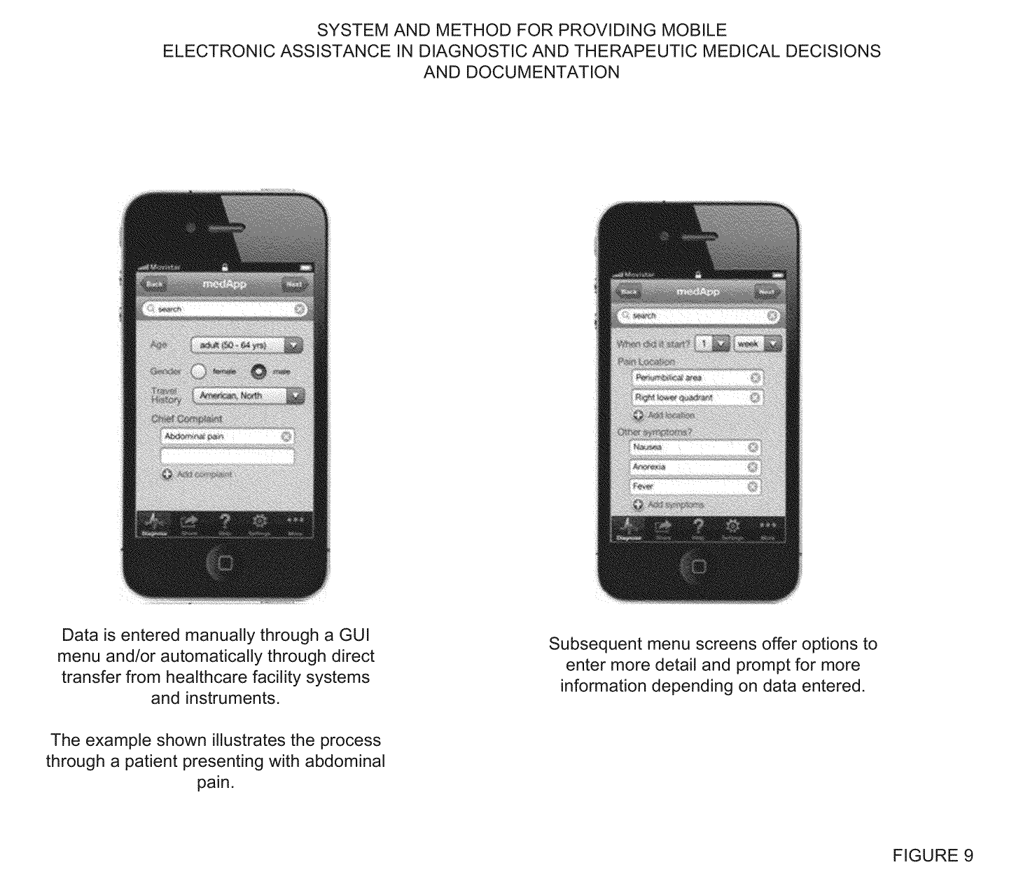

In one embodiment, referring to FIG. 9, the user can enter vital information for a patient such as age, gender, temperature, blood pressure, and the like.

In one embodiment, the application can guide the user to enter in certain symptoms which in turn, prompt for more specific inquiry into another area. For example, referring to FIG. 9, the chief complaint is entered as “abdominal pain” which in turn prompts more specific entry of pain location and symptoms.

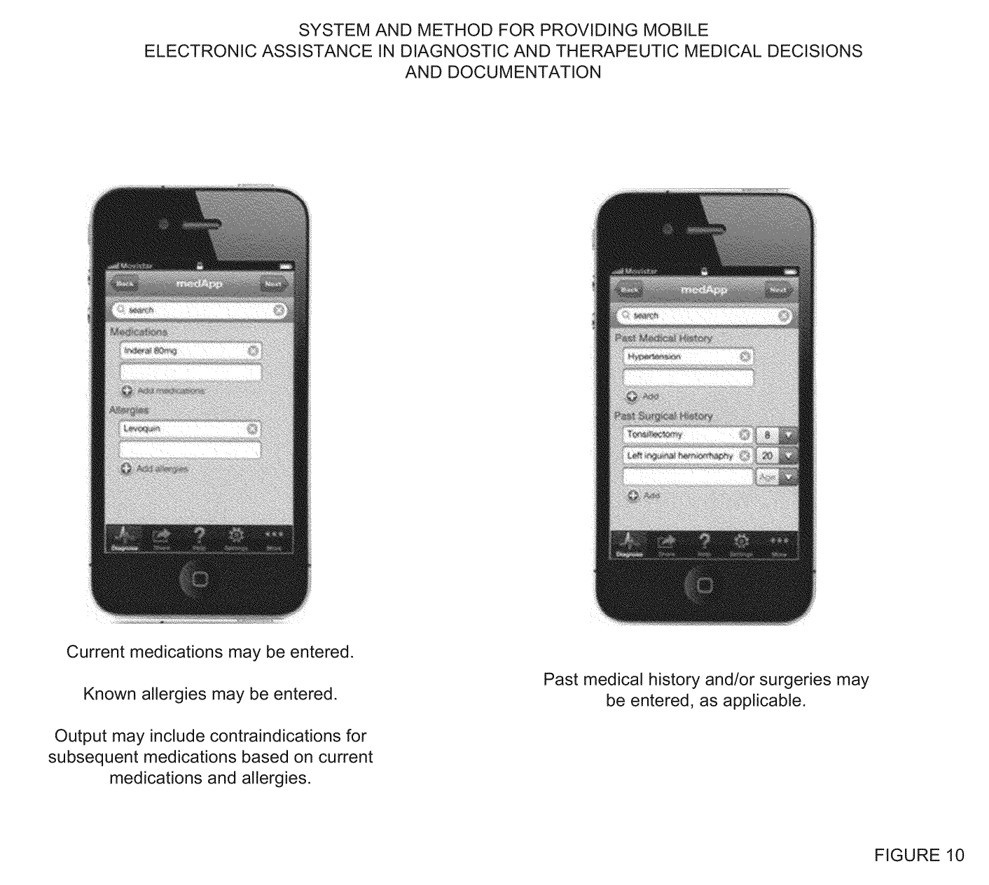

In one embodiment, referring to FIG. 10, the application contains a menu for entry of medications and allergies so that newly proposed medications and/or treatment are not contraindicated.

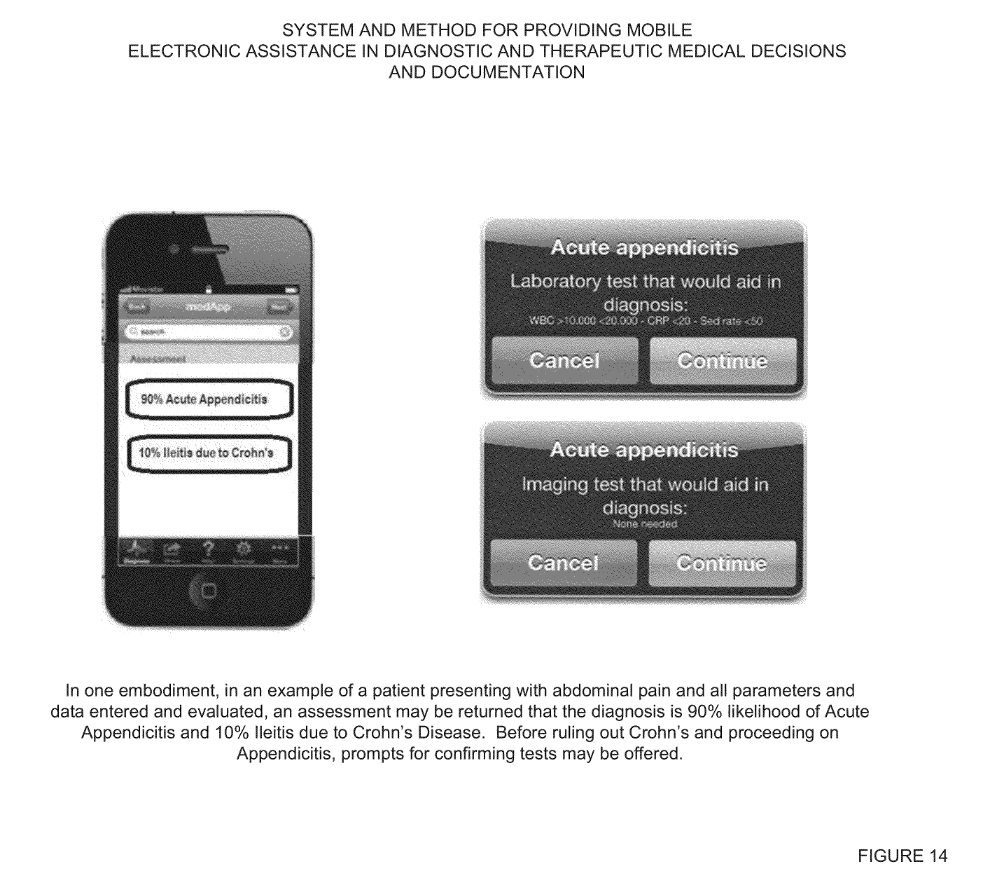

In one embodiment, on the basis of correlating all inputted information, including but not limited to demographics, history, and physical exam, potential diagnoses and likelihood of correctness is presented. Thus, referring to FIG. 14, a diagnosis could be presented as 90% likelihood of Acute Appendicitis, but noting the 10% possibility of Ileitis due to Crohn's Disease, which if overlooked, may cause an unnecessary appendectomy as well as delay appropriate treatment.

In one embodiment, referring to FIG. 14, the application then suggests tests that would aid in confirming or excluding certain presented diagnoses with an option to order such testing.

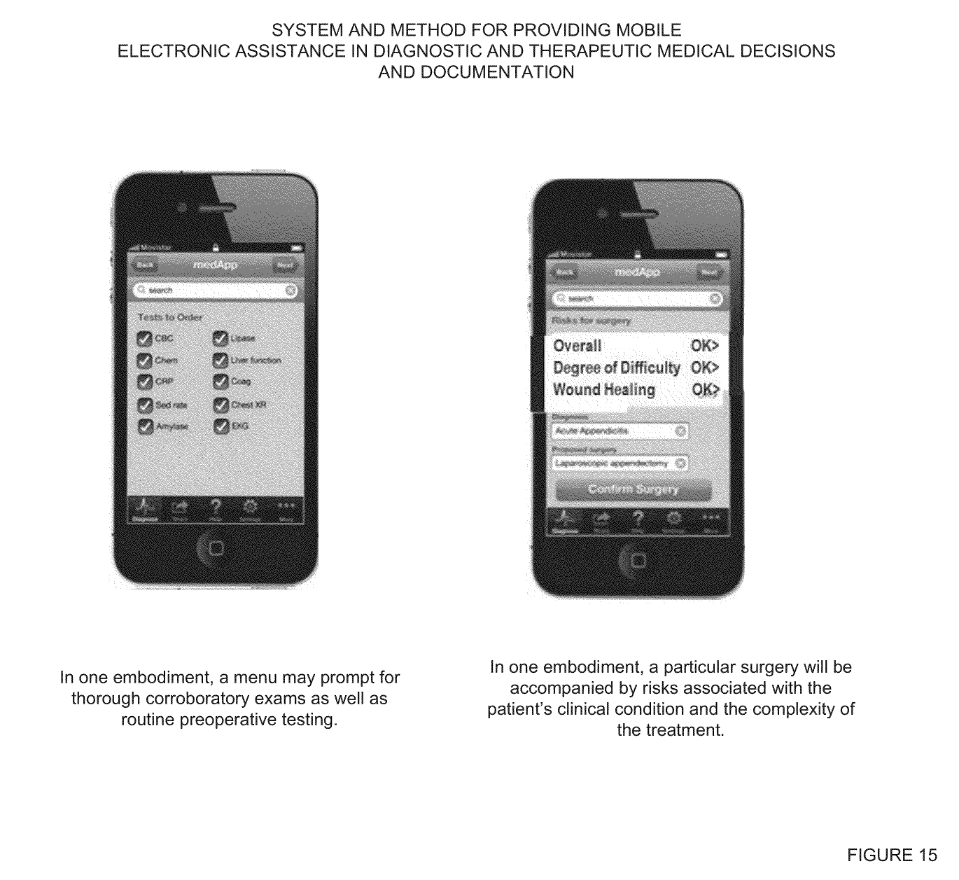

In one embodiment, upon settling on a diagnosis, treatment options are presented with patient risks. For example, referring to FIG. 15, upon concluding a diagnosis of Appendicitis, a proposed surgery of Laparoscopic Appendectomy is presented with risks, degree of technical difficulty and prognosis of wound healing. The application offers a step by step review of the operation to assure the attending healthcare service provider that they are capable of performing it and providing technical instruction and illustration to assist the less experienced practitioner through a procedure they may have never performed before.

Each and every feature described herein, and each and every combination of two or more of such features, is included within the scope of the present invention provided that the features included in such a combination are not mutually exclusive.

What is claimed is:

1. A system that enables diagnostic and treatment assistance to the user, the system comprising:
a) a computing device application;
b) a computing device;
c) a user interface;
d) wherein said interface grants said user access to said application loaded onto said computing device configured to:
(i) gather patient specific data;
(ii) interface with established databases of healthcare information;
(iii) compare said patient specific data with said established databases of healthcare information;
(iv) generate and display possible diagnoses in order of likelihood;
(v) generate and display at least one treatment option for any given and non-excluded diagnosis;
(vi) generate a therapeutic plan; and
(vii) generate at least one electronic health record relating to said patient.

2. The system of claim 1, wherein said computing device is a handheld, mobile computing device.

3. The system of claim 1, wherein said application is configured to prompt the user to consider lower likelihood diagnoses that if true and dismissed would impose a high risk to said patient.

4. The system of claim 1, wherein said application is configured to guide said user to implement diagnostic modalities of proven efficacy for any given and non-excluded diagnosis.

5. The system of claim 1, wherein said application is configured to guide said user to implement therapeutic modalities of proven efficacy for any given and non-excluded diagnosis.

6. The system of claim 1, wherein said application is configured to demonstrate, guide, instruct and complement a user to provide a level of treatment said user would not otherwise be capable of providing.

7. The system of claim 1, wherein said application is configured to correct and re-diagnose based upon input resulting from treatment or other changes.

8. The system of claim 1, wherein said application is configured to receive manually inputted patient specific information.

9. The system of claim 1, wherein said application is configured to interface with medical diagnostic tools to receive patient-specific information.

10. The system of claim 1, wherein said application is configured to interface with medical treatment tools to receive patient-specific information.

11. The system of claim 1, wherein said application is configured to enable a healthcare provider to perform a real-time examination and input corresponding patient-specific data.

12. The system of claim 1, wherein said application is configured to create a patient data file containing at least one category of information pertinent to said patient.

13. A method that enables a user to access and utilize a computing device loaded with a computer application enabled to provide diagnostic and treatment assistance and instruction and guidance with implementation of treatment, the method comprising the steps of:
a) loading a computing device application onto a computing device of user,
b) launching a user interface allowing user to use said application;
c) granting a user access to said application configured to gather patient specific data through a log-in procedure;
d) interfacing with established databases of healthcare information;
e) comparing said patient specific data with said established databases of healthcare information;
f) generating and displaying possible diagnoses in order of likelihood;
g) generating and displaying at least one treatment option for any given and non-excluded diagnosis; and
h) generating at least one electronic health record relating to said patient.

14. The method of claim 13, wherein said computing device is a handheld, mobile computing device.

15. The method of claim 13, wherein the additional step of prompting the user to consider lower likelihood diagnoses that if true and dismissed would impose a high risk to said patient is added.

16. The method of claim 13, wherein the additional step of guiding the user to implement diagnostic and therapeutic modalities of proven efficacy for any given and non-excluded diagnosis is added.

17. The method of claim 13, wherein the additional step of demonstrating, guiding, instructing and complementing a user to provide a level of treatment said user would not otherwise be capable of providing is added.

18. The method of claim 13, wherein the additional step of correcting and re-diagnosing based upon input resulting from treatment or other changes is added.

19. The method of claim 13, wherein the additional step of a user performing a real-time examination and inputting patient-specific data is added.

20. The method of claim 13, wherein the additional step of creating a patient data file containing at least one category of information pertinent to said patient is added.
